(19) United States
(12) Patent Application Publication
(10) Pub. No.: US 2019/0195902 A1
(43) Pub. Date: Jun. 27, 2019

(54) REAGENT STORAGE CABINET AND AUTOMATIC ANALYZING APPARATUS INCLUDING REAGENT STORAGE CABINET

(71) Applicants: KAWASAKI JUKOGYO KABUSHIKI KAISHA, Kobe-shi (JP); MEDICAROID CORPORATION, Kobe-shi (JP)

(72) Inventors: Yukio IWASAKI, Kobe-shi (JP); Satoshi OUCHI, Kobe-shi (JP); Eiji MITSUI, Kobe-shi (JP); Junichi MATSUOKA, Kobe-shi (JP); Yukihiko KITANO, Kobe-shi (JP)

(73) Assignees: KAWASAKI JUKOGYO KABUSHIKI KAISHA, Kobe-shi (JP); MEDICAROID CORPORATION, Kobe-shi (JP)

(21) Appl. No.: 16/232,469

(22) Filed: Dec. 26, 2018

(30) Foreign Application Priority Data
Dec. 26, 2017 (JP) 2017-250242

(51) Int. Cl. G01N 35/00; G01N 35/10; B01L 9/02

(52) U.S. Cl. CPC G01N 35/0099; G01N 35/1002; B01L 2200/16; B01L 2200/08; B01L 9/02

(57) ABSTRACT

A reagent storage arranged at a predetermined position where predetermined work is able to be performed by a robot. The reagent storage cabinet includes: a container accommodating portion including an upper-surface opening portion and accommodating a reagent container; and a storage cabinet main body including a front-surface opening portion through which the container accommodating portion is put in and pulled out and a storage space communicating with the front-surface opening portion and accommodating the container accommodating portion. In an accommodated state that is a state where the container accommodating portion is accommodated in storage cabinet main body, the upper-surface opening portion of the container accommodating portion is sealed. In a pulled-out state that is a state where the container accommodating portion is pulled out from storage cabinet main body, the robot is able to directly access, from above, a reagent in the reagent container accommodated in the container accommodating portion.

### BACKGROUND OF THE INVENTION

### 1. Field of the Invention

The present invention relates to a reagent storage cabinet and an automatic analyzing apparatus including the reagent storage cabinet.

### 2. Description of the Related Art

Conventionally known is an automatic analyzing apparatus configured to automatically execute chemical analysis, such as biochemical analysis or immunoassay, in clinical examination. For example, JP 2014-119328 A1 discloses a reagent storage cabinet including a cooling mechanism for cooling a reagent bottle in order to prevent deterioration of analytical data by denaturation of a reagent used in analysis, and also discloses an automatic analyzing apparatus including the reagent storage cabinet. This reagent storage cabinet includes: a reagent holding drawer including small sections at which reagent bottles are provided; and a reagent storage tubular body having a square tube shape and accommodating the reagent holding drawer. A bottle upper surface of each reagent bottle has a reagent suction port through which a reagent is suctioned. Each reagent bottle is inserted in the small section with the suction port open. Operations of inserting and taking out the reagent bottles are performed by an operator.

In recent years, proposed in various fields is that a robot and an operator work together in the same work space. Therefore, also regarding the above-described automatic analyzing apparatus, the automation of all operations by introducing a robot has been considered.

However, according to the reagent storage cabinet and the automatic analyzing apparatus including the reagent storage cabinet in the above prior art, for example, the operations of inserting and taking out the reagent bottles in the reagent storage cabinet are performed by an operator. Therefore, there is still room for improvement regarding the introduction of a robot.

### SUMMARY OF THE INVENTION

The present invention was made to solve the above problems, and an object of the present invention is to provide a reagent storage cabinet suitable for operations performed by a robot, and an automatic analyzing apparatus including the reagent storage cabinet.

A reagent storage cabinet according to one aspect of the present invention is a reagent storage cabinet arranged at a predetermined position where predetermined work is able to be performed by a robot, the reagent storage cabinet including: a container accommodating portion including an upper-surface opening portion and accommodating a reagent container; and a storage cabinet main body including a front-surface opening portion through which the container accommodating portion is put in and pulled out and a storage space communicating with the front-surface opening portion and accommodating the container accommodating portion, wherein: in an accommodated state that is a state where the container accommodating portion is accommodated in the storage cabinet main body, the upper-surface opening portion of the container accommodating portion is sealed; and in a pulled-out state that is a state where the container accommodating portion is pulled out from the storage cabinet main body, the robot is able to directly access, from above, a reagent in the reagent container accommodated in the container accommodating portion.

According to the above configuration, the container accommodating portion accommodating the reagent container can be put in and pulled out from the storage space through the front-surface opening portion. With this, in the state where the container accommodating portion is accommodated in the storage cabinet main body, the upper-surface opening portion of the container accommodating portion is sealed, and therefore, the reagent can be stored. On the other hand, in the state where the container accommodating portion is pulled out from the storage cabinet main body, the robot can directly access, from above, the reagent in the reagent container accommodated in the container accommodating portion and can perform, for example, dispensing work.

An inner bottom surface of the container accommodating portion may be inclined with respect to a horizontal direction.

According to the above configuration, the inner bottom surface of the container accommodating portion is inclined with respect to the horizontal direction. Therefore, as the reagent is consumed, the reagent in the container gathers in an inclination direction. With this, the reagent in the container can be substantially completely consumed.

The inner bottom surface of the container accommodating portion may be inclined such that a rear end thereof is located lower than a front end thereof.

According to the above configuration, the inner bottom surface of the container accommodating portion is inclined such that the rear end thereof is located lower than the front end thereof. Therefore, as the reagent in the container accommodated in the container accommodating portion is consumed, the reagent gathers at an opposite side to a side where the robot works. The reagent is suctioned by the pipette attached to the tip end (end effector) of the robot, for example. A tip end portion of the pipette can access the reagent in the container more easily when the reagent gathers at the opposite side to the side where the robot works than when the reagent gathers at the side where the robot works.

The reagent storage cabinet may further include a slide mechanism by which the container accommodating portion is automatically put in and pulled out from the storage cabinet main body.

According to the above configuration, the container accommodating portion can be automatically put in and pulled out from the storage cabinet main body by the slide mechanism. By adjusting an open/close speed to an appropriate speed, the reagent in liquid form does not spill from the upper-surface opening portion of the reagent container.

The slide mechanism may be operated by an external shaft of the robot.

According to the above configuration, the slide mechanism is operated by the external shaft of the robot. Therefore, the slide mechanism can be operated in conjunction with, for example, a control operation of a dispensing robot.

The reagent storage cabinet may further include a mounting table arranged under the container accommodating portion in the pulled-out state, another reagent container being placed on the mounting table, wherein in the state where the container accommodating portion is accommodated in the storage cabinet main body, the robot may be able to directly access, from above, the reagent in the another reagent container placed on the mounting table.

According to the above configuration, in the state where the container accommodating portion is accommodated in the storage cabinet main body, the robot can directly access, from above, the reagent in the reagent container placed on the mounting table and can perform, for example, dispensing work.

A mounting surface of the mounting table may be inclined with respect to a horizontal direction.

According to the above configuration, the mounting surface of the mounting table is inclined with respect to the horizontal direction. Therefore, as the reagent in the container is consumed, the reagent gathers in the inclination direction. With this, the reagent in the container can be substantially completely consumed by, for example, a suction nozzle of an automatic analyzing apparatus.

The mounting surface of the mounting table may be inclined such that a rear end thereof is located lower than a front end thereof.

According to the above configuration, the mounting surface of the mounting table is inclined such that the rear end thereof is located lower than the front end thereof. Therefore, as the reagent in the container placed on the mounting table is consumed, the reagent gathers at the opposite side to the side where the robot works. The reagent is suctioned by the pipette attached to the tip end (end effector) of the robot, for example. The tip end portion of the pipette can access the reagent in the container more easily when the reagent gathers at the opposite side to the side where the robot works than when the reagent gathers at the side where the robot works.

An automatic analyzing apparatus according to another aspect of the present invention is an automatic analyzing apparatus including the above reagent storage cabinet.

The above object, other objects, features, and advantages of the present invention will be made clear by the following detailed explanation of preferred embodiments with reference to the attached drawings.

### BRIEF DESCRIPTION OF THE DRAWINGS

FIG. 1 is a perspective view showing the configuration of an automatic analyzing apparatus according to the present embodiment.

FIGS. 2A and 2B are perspective views showing a reagent storage cabinet of FIG. 1.

FIGS. 3A and 3B are plan views showing the reagent storage cabinet of FIG. 1.

FIG. 4A is a sectional view taken along line IV-IV of FIG. 3A, and FIG. 4B is a sectional view taken along line IV-IV of FIG. 3B.

FIG. 5 is a perspective view showing the configuration of an end effector of a reagent dispensing robot of FIG. 1.

FIGS. 6A and 6B are schematic diagrams for explaining operations of the reagent dispensing robot.

### DESCRIPTION OF THE PREFERRED EMBODIMENTS

Hereinafter, a preferred embodiment will be explained with reference to the drawings. In the following explanations and the drawings, the same reference signs are used for the same or corresponding components, and a repetition of the same explanation is avoided. In addition, for ease of understanding, the drawings schematically show the components.

Automatic Analyzing Apparatus

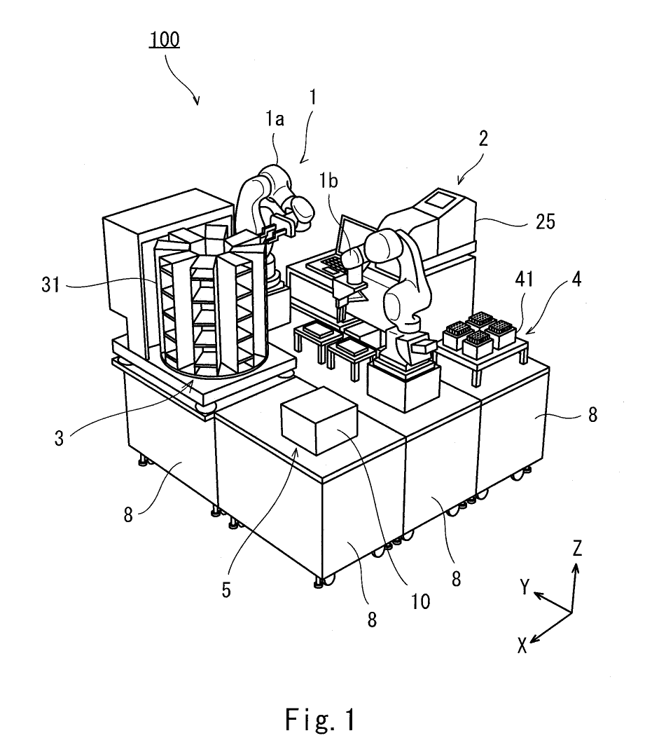

FIG. 1 is a perspective view showing the configuration of an automatic analyzing apparatus according to the present embodiment. An automatic analyzing apparatus 100 of the present embodiment detects the concentration of an antibody in a reagent by using ELISA (Enzyme-Linked Immunosorbent Assay). The automatic analyzing apparatus 100 includes a robot module 1, an inspection equipment module 2, a stocker module 3, a chip rack module 4, and a reagent tank module 5. Bases 8 supporting the modules (1 to 4) are substantially the same in height as one another. Connecting members (not shown) attachable to and detachable from each other are provided at side surfaces of the bases 8. Therefore, the modules can be easily connected to and separated from one another, and the layout of the automatic analyzing apparatus 100 is flexibly changeable.

The robot module 1 includes two work robots (1a and 1b) arranged on the base 8. These robots are controlled by a control device (not shown). A plate transfer robot 1a includes a vertical articulated robot arm and a transferring end effector attached to a tip end of the robot arm. A reagent dispensing robot 1b includes a vertical articulated robot arm and a dispensing end effector attached to a tip end of the robot arm.

The inspection equipment module 2 includes an inspection equipment 25 arranged on the base 8. The inspection equipment 25 inspects a plate containing a reagent. The stocker module 3 includes a plate rack 31 arranged on the base 8. The plate rack 31 accommodates and stores a plurality of plates. The chip rack module 4 includes a chip rack 41 arranged on the base 8. A plurality of chips are arranged at the chip rack 41. The reagent tank module 5 includes a reagent storage cabinet 10 arranged on the base 8. The chip rack 41, the reagent storage cabinet 10, the plate rack 31, and the inspection equipment 25 are arranged at predetermined positions where predetermined wok can be performed by the two robots (1a and 1b). The reagent storage cabinet 10 and the plate rack 31 are controlled by the control device (not shown). The reagent dispensing robot 1b attaches a chip (not shown), arranged at the chip rack 41, to a pipette (not shown) and pours the reagent, stored in the reagent storage cabinet 10, into the chip by using the pipette. The plate transfer robot 1a takes out the plate accommodated in the plate rack 31 and arranges the plate on a worktable of the plate transfer robot 1a. The reagent dispensing robot 1b pours the reagent through the chip into the plate arranged on the worktable. The plate transfer robot 1a transfers the plate, into which the reagent has been poured, from the worktable to a predetermined position of the inspection equipment 25 and sets the plate at the inspection equipment 25. The inspection equipment 25 inspects the plate into which the reagent has been poured.

Reagent Storage Cabinet

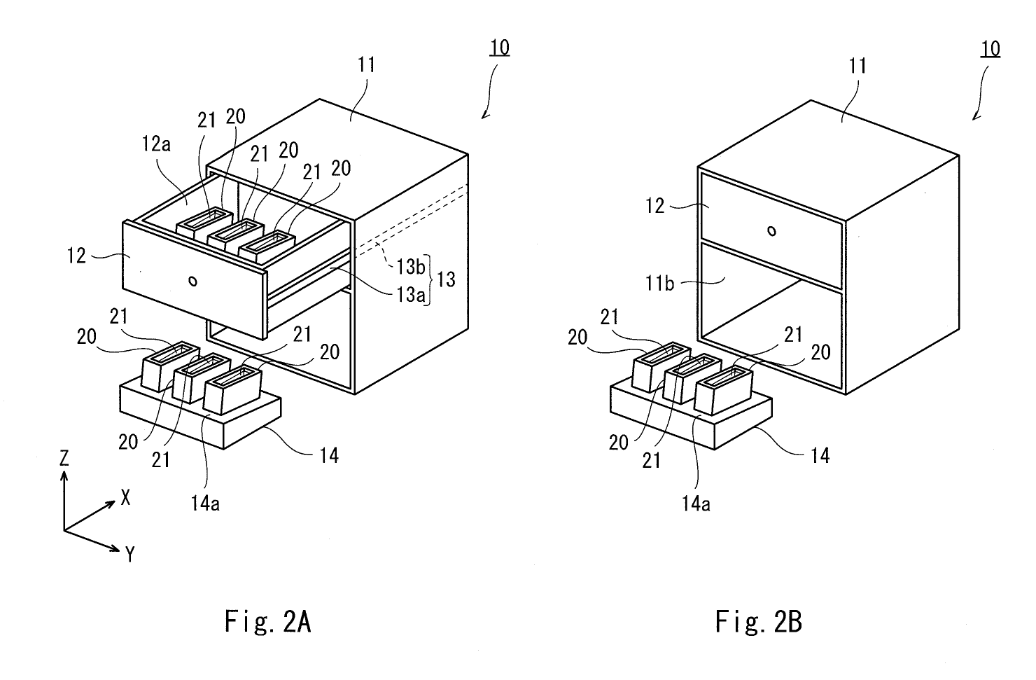

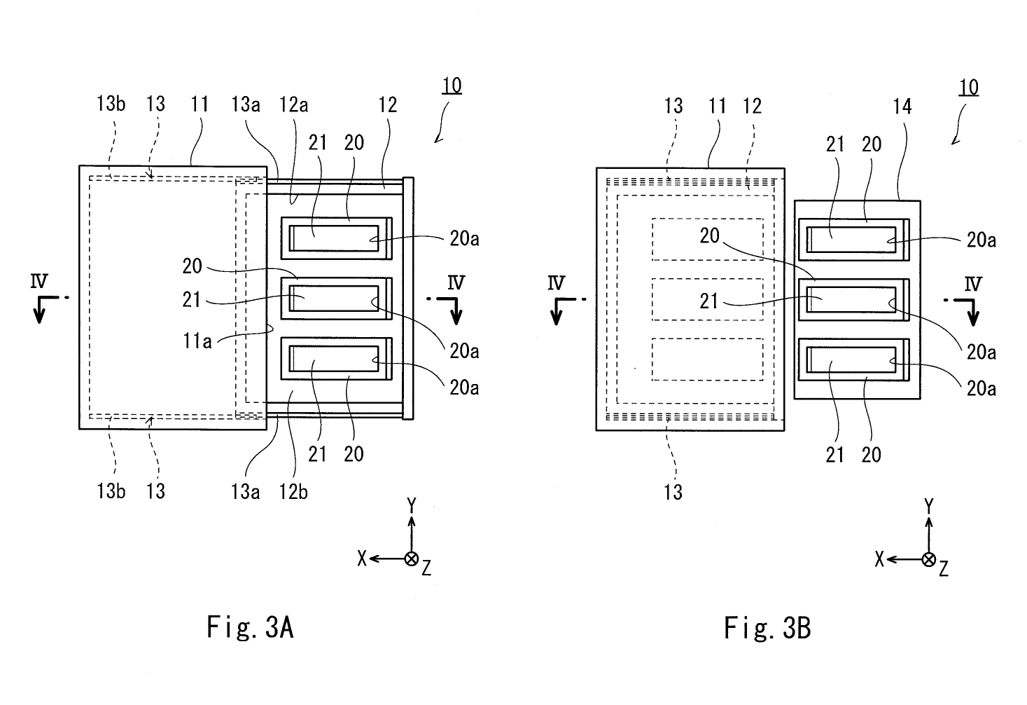

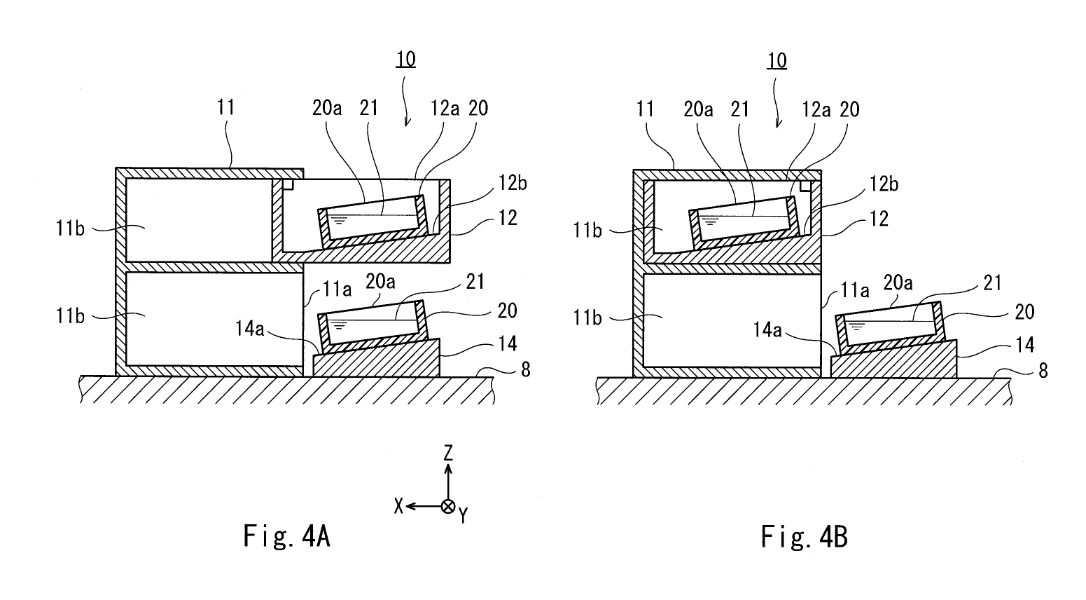

Next, the configuration of the reagent storage cabinet 10 will be explained with reference to the drawings. FIGS. 2A and 2B are perspective views showing the reagent storage cabinet 10. FIGS. 3A and 3B are plan views showing the reagent storage cabinet 10. FIG. 4A is a sectional view taken along line IV-IV of FIG. 3A, and FIG. 4B is a sectional view taken along line IV-IV of FIG. 3B.

The reagent storage cabinet 10 includes: a container accommodating portion 12; a storage cabinet main body 11 accommodating the container accommodating portion 12; and slide mechanisms 13 by which the container accommodating portion 12 can slide with respect to the storage cabinet main body 11 in a front-rear direction (a direction parallel to an X-axis in the drawings). The reagent container 20 is a box body including a rectangular upper-surface opening portion 20a. A reagent 21 in liquid form is present in the reagent container 20.

The container accommodating portion 12 is a box body including a rectangular upper-surface opening portion 12a. The container accommodating portion 12 includes an inner bottom surface 12b at which three reagent containers 20 can be arranged side by side. The three reagent containers 20 are accommodated in the container accommodating portion 12. First members 13a of the slide mechanisms 13 are provided at both respective outer wall surfaces of the container accommodating portion 12.

The storage cabinet main body 11 includes: a front-surface opening portion 11a; and a storage space 11b communicating with the front-surface opening portion 11a. The front-surface opening portion 11a is formed in a rectangular shape such that the container accommodating portion 12 is put in and pulled out from the storage cabinet main body 11. The storage space 11b is formed in a substantially cube shape so as to accommodate the container accommodating portion 12. The container accommodating portion 12 can be put in and pulled out from the storage space 11b through the front-surface opening portion 11a. Second members 13b of the slide mechanisms 13 are provided at both respective inner wall surfaces of the storage cabinet main body 11.

Each of the slide mechanisms 13 includes: the first member 13a provided at the outer wall surface of the container accommodating portion 12; and the second member 13b provided at the inner wall surface of the storage cabinet main body 11. The container accommodating portion 12 can slide with respect to the storage cabinet main body 11 in the front-rear direction (the direction parallel to the X-axis in the drawings). In the present embodiment, the slide mechanisms 13 are operated by an external shaft of the reagent dispensing robot 1b. To be specific, the container accommodating portion 12 is configured to be automatically put in and pulled out from the storage cabinet main body 11 (see FIGS. 3A and 3B).

As shown in FIGS. 3B and 4B, in an accommodated state that is a state where the container accommodating portion 12 is accommodated in the storage cabinet main body 11, the upper-surface opening portion 12a of the container accommodating portion 12 is sealed. With this, the reagent accommodated in the container accommodating portion 12 can be shielded from light and can be prevented from evaporating. On the other hand, as shown in FIGS. 3A and 4A, in a pulled-out state that is a state where the container accommodating portion 12 is pulled out from the storage cabinet main body 11, the reagent dispensing robot 1b can directly access, from above, the reagent 21 in the reagent container 20 accommodated in the container accommodating portion 12.

Further, as shown in FIGS. 4A and 4B, the inner bottom surface 12b of the container accommodating portion 12 is inclined with respect to a horizontal direction (an X-Y plane in the drawings). In the present embodiment, the inner bottom surface 12b of the container accommodating portion 12 is inclined at 1° with respect to the horizontal direction. It should be noted that the inclination angle is exaggeratingly shown in the drawings. Further, the inner bottom surface 12b of the container accommodating portion 12 is inclined such that a rear end thereof (a positive side of the X-axis in the drawings) is located lower than a front end thereof (a negative side of the X-axis in the drawings).

As shown in FIG. 4A, the reagent storage cabinet 10 further includes a mounting table 14. The mounting table 14 is arranged under the container accommodating portion 12 in the pulled-out state, and another reagent container 20 is placed on the mounting table 14. As shown in FIG. 4B, in a state where the container accommodating portion 12 is accommodated in the storage cabinet main body 11, the robot 1b can directly access, from above, the reagent 21 in the reagent container 20 placed on the mounting table 14. A mounting surface 14a of the mounting table 14 is inclined with respect to the horizontal direction. In the present embodiment, the mounting surface 14a of the mounting table 14 is inclined at 1° with respect to the horizontal direction. It should be noted that the inclination angle is exaggeratingly shown in the drawings. The mounting surface of the mounting table is inclined such that a rear end thereof (a positive side of the X-axis in the drawings) is located lower than a front end thereof (a negative side of the X-axis in the drawings).

Dispensing Operation

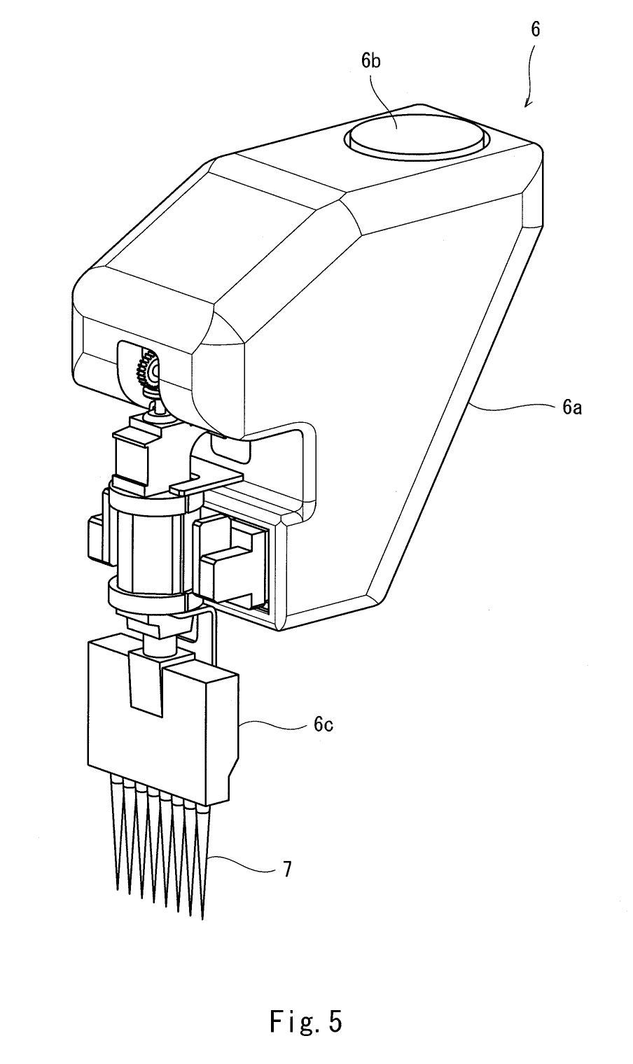

Next, operations of the automatic analyzing apparatus 100 will be explained with reference to the drawings. Hereinafter, operations of the reagent dispensing robot 1b will be mainly explained. FIG. 5 is a perspective view showing the configuration of an end effector 6 attached to a tip end of the reagent dispensing robot 1b. As shown in FIG. 5, the end effector 6 includes: a main body portion 6a; a mechanical interface 6b provided at an upper portion of the main body portion 6a; and a pipette portion 6c. In the present embodiment, the pipette portion 6c is a multichannel pipette to which eight pipettes 7 are attached. It should be noted that the number of pipettes 7 attached to the pipette portion 6c may be 1, 12, 16, 48, or 64. The pipette portion 6c is provided with two types of plungers (i.e., a dispensing plunger and a chip release plunger). These plungers are controlled by a robot controller (not shown). Special pipette chips (not shown) are attached to respective tip ends of the pipettes 7. The reagent is suctioned by the dispensing plunger through the pipette chips and is then poured into the plate.

According to conventional pipette work performed by humans, the chip (pipette 7) is not sunk in a solution (reagent), i.e., the solution (reagent) is prevented from adhering to an outside of the chip (pipette 7). On the other hand, the pipette work performed by the reagent dispensing robot 1b according to the present embodiment is different from the pipette work performed by humans.

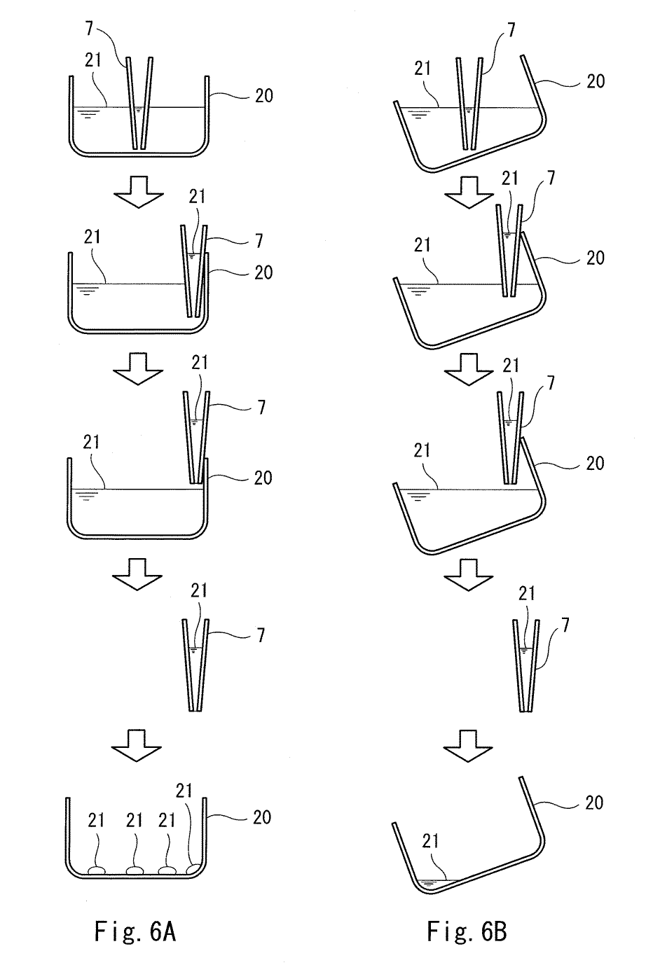

As Comparative Example, FIG. 6A shows a case where the robot 1b suctions the reagent 21 in the reagent container 20 placed on a horizontal worktable. FIG. 6A shows only the pipette 7 and the reagent container 20 for convenience sake. As shown in FIG. 6A, when the robot 1b suctions the reagent, the amount of solution (reagent) cannot be recognized, so that the chip (pipette 7) is brought into contact with the bottom of the reagent container 20. Then, an operation of suctioning extra solution (reagent) adhering to the outside of the chip (pipette 7) is performed. Since the reagent container 20 is arranged on the horizontal worktable, the solution (reagent) is consumed and finally dotted on the bottom of the reagent container 20. Therefore, according to Comparative Example, the reagent 21 cannot be completely consumed.

On the other hand, FIG. 6B shows a case where the robot 1b suctions the reagent 21 in the reagent container 20 accommodated in the reagent storage cabinet 10 according to the present embodiment. Each of the inner bottom surface 12b of the container accommodating portion 12 and the mounting surface 14a of the mounting table 14 is slightly inclined with respect to the horizontal direction. Therefore, as shown in FIG. 6B, as the reagent 21 is consumed, the reagent 21 in the reagent container 20 gathers in an inclination direction. With this, the reagent 21 in the reagent container 20 can be substantially completely consumed. Further, each of the inner bottom surface 12b of the container accommodating portion 12 and the mounting surface 14a of the mounting table 14 is inclined such that the rear end thereof is located lower than the front end. Therefore, as the reagent 21 is consumed, the reagent 21 in the reagent container 20 accommodated in the container accommodating portion 12 gathers at an opposite side to a side where the robot 1b works. The reagent 21 is suctioned by the pipette 7 attached to the tip end (end effector 6) of the robot 1b, for example. A tip end portion of the pipette 7 can access the reagent 21 in the reagent container 20 more easily when the reagent 21 gathers at the opposite side to the side where the robot 1b works than when the reagent 21 gathers at the side where the robot 1b works.

In the present embodiment, each of the inclination angle of the inner bottom surface 12b of the container accommodating portion 12 and the inclination angle of the mounting surface 14a of the mounting table 14 is 1°. However, the present invention is not limited to this as long as they are slightly inclined. For example, the inclination angle may be in a range of more than 0° and not more than 1° or in a range of more than 0° and not more than 5°.

### Other Embodiments

In the present embodiment, the reagent storage cabinet 10 stores the reagent 21. However, the present invention is not limited to the reagent 21, and the reagent storage cabinet 10 may store a specimen (such as blood or biotissue sampled from a human body).

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the scope of the present invention.

What is claimed is:

1. A reagent storage cabinet arranged at a predetermined position where predetermined work is able to be performed by a robot,
the reagent storage cabinet comprising:
a container accommodating portion including an upper-surface opening portion and accommodating a reagent container; and
a storage cabinet main body including
a front-surface opening portion through which the container accommodating portion is put in and pulled out and
a storage space communicating with the front-surface opening portion and accommodating the container accommodating portion, wherein:
in an accommodated state that is a state where the container accommodating portion is accommodated in the storage cabinet main body, the upper-surface opening portion of the container accommodating portion is sealed; and
in a pulled-out state that is a state where the container accommodating portion is pulled out from the storage cabinet main body, the robot is able to directly access, from above, a reagent in the reagent container accommodated in the container accommodating portion.

2. The reagent storage cabinet according to claim 1, wherein an inner bottom surface of the container accommodating portion is inclined with respect to a horizontal direction.

3. The reagent storage cabinet according to claim 2, wherein the inner bottom surface of the container accommodating portion is inclined such that a rear end thereof is located lower than a front end thereof.

4. The reagent storage cabinet according to claim 1, further comprising a slide mechanism by which the container accommodating portion is automatically put in and pulled out from the storage cabinet main body.

5. The reagent storage cabinet according to claim 2, further comprising a slide mechanism by which the container accommodating portion is automatically put in and pulled out from the storage cabinet main body.

6. The reagent storage cabinet according to claim 3, further comprising a slide mechanism by which the container accommodating portion is automatically put in and pulled out from the storage cabinet main body.

7. The reagent storage cabinet according to claim 4, wherein the slide mechanism is operated by an external shaft of the robot.

8. The reagent storage cabinet according to claim 5, wherein the slide mechanism is operated by an external shaft of the robot.

9. The reagent storage cabinet according to claim 6, wherein the slide mechanism is operated by an external shaft of the robot.

10. The reagent storage cabinet according to claim 1, further comprising a mounting table arranged under the container accommodating portion in the pulled-out state, another reagent container being placed on the mounting table, wherein
in the state where the container accommodating portion is accommodated in the storage cabinet main body, the robot is able to directly access, from above, the reagent in the another reagent container placed on the mounting table.

11. The reagent storage cabinet according to claim 2, further comprising a mounting table arranged under the container accommodating portion in the pulled-out state, another reagent container being placed on the mounting table, wherein
in the state where the container accommodating portion is accommodated in the storage cabinet main body, the robot is able to directly access, from above, the reagent in the another reagent container placed on the mounting table.

12. The reagent storage cabinet according to claim 3, further comprising a mounting table arranged under the container accommodating portion in the pulled-out state, another reagent container being placed on the mounting table, wherein
in the state where the container accommodating portion is accommodated in the storage cabinet main body, the robot is able to directly access, from above, the reagent in the another reagent container placed on the mounting table.

13. The reagent storage cabinet according to claim 4, further comprising a mounting table arranged under the container accommodating portion in the pulled-out state, another reagent container being placed on the mounting table, wherein
in the state where the container accommodating portion is accommodated in the storage cabinet main body, the robot is able to directly access, from above, the reagent in the another reagent container placed on the mounting table.

14. The reagent storage cabinet according to claim 5, further comprising a mounting table arranged under the container accommodating portion in the pulled-out state, another reagent container being placed on the mounting table, wherein
in the state where the container accommodating portion is accommodated in the storage cabinet main body, the robot is able to directly access, from above, the reagent in the another reagent container placed on the mounting table.

15. The reagent storage cabinet according to claim 10, wherein a mounting surface of the mounting table is inclined with respect to a horizontal direction.

16. The reagent storage cabinet according to claim 15, wherein the mounting surface of the mounting table is inclined such that a rear end thereof is located lower than a front end thereof.

17. An automatic analyzing apparatus comprising:
a robot;
a reagent storage cabinet arranged at a predetermined position where predetermined work is able to be performed by the robot; and
an inspection equipment configured to inspect a specimen by using a reagent stored by the reagent storage cabinet, wherein the reagent storage cabinet comprises:
a container accommodating portion including an upper-surface opening portion and accommodating a reagent container; and
a storage cabinet main body including
a front-surface opening portion through which the container accommodating portion is put in and pulled out and
a storage space communicating with the front-surface opening portion and accommodating the container accommodating portion, wherein:
in an accommodated state that is a state where the container accommodating portion is accommodated in the storage cabinet main body, the upper-surface opening portion of the container accommodating portion is sealed; and
in a pulled-out state that is a state where the container accommodating portion is pulled out from the storage cabinet main body, the robot is able to directly access, from above, a reagent in the reagent container accommodated in the container accommodating portion.

18. The automatic analyzing apparatus according to claim 17, wherein an inner bottom surface of the container accommodating portion is inclined with respect to a horizontal direction.

19. The automatic analyzing apparatus according to claim 18, wherein the inner bottom surface of the container accommodating portion is inclined such that a rear end thereof is located lower than a front end thereof.

20. The automatic analyzing apparatus according to claim 17, further comprising a slide mechanism by which the container accommodating portion is automatically put in and pulled out from the storage cabinet main body.
